(19) United States
(12) Patent Application Publication
(10) Pub. No.: US 2018/0035844 A1
(43) Pub. Date: Feb. 8, 2018

(54) GRILL AND GRILL ASSEMBLY

(71) Applicant: John Paul PYLE, Conshohocken, PA (US)

(72) Inventor: John Paul PYLE, Conshohocken, PA (US)

(21) Appl. No.: 15/660,659

(22) Filed: Jul. 26, 2017

Related U.S. Application Data
(60) Provisional application No. 62/370,570, filed on Aug. 3, 2016.

(51) Int. Cl. A47J 37/07

(52) U.S. Cl. CPC A47J 37/0704

(57) ABSTRACT

A grill and a grill assembly are disclosed. A grill includes a main body and a lid attached to the main body such that the lid is selectively moveable between a closed position and an open position, thereby covering or exposing the cooking grid and the heat source when the cooking grid and the heat source are received by the main body. The lid includes one or more openings in one or more of the front wall and side walls of the lid. Each opening is selectively closed and opened by one or more opening members attached to the lid. Each opening member is selectively moveable between a closed position and an open position independently of the lid such that one or more of the opening members is openable or closable while the lid remains attached to the main body in the closed position.

### CROSS REFERENCE TO RELATED APPLICATIONS

This application claims the benefit of Provisional U.S. Patent Application Ser. No. 62/370,570 filed on Aug. 3, 2016, the entire contents of which are incorporated herein by reference.

### TECHNICAL FIELD

The present disclosure relates to a grill and a grill assembly, and more particularly a grill and a grill assembly including an opening in the lid of the grill, which can be closed and opened while the lid remains closed.

### BACKGROUND INFORMATION

Conventional grills include a grill base and an openable grill lid that is either hinged to the grill base or completely detachable from the grill base to provide access to a cooking grid. Some food items are grilled with the lid closed. During grilling, it is conventional for users to intermittently open the grill lid to attend to the food items. The intermittent opening of the grill lid leads to several problems, including heat loss and uneven cooking temperature. This can lead to unreliable cooking conditions and uneven cooking results. The opening of the grill lid can also lead to energy waste, as large volumes of warm air escape from the grill.

### SUMMARY

In one aspect, the present disclosure relates to a grill that includes a main body possessing a back wall and an open top, and configured to receive a cooking grid and a heat source below the cooking grid; and a lid possessing a top wall, a back wall, a front wall, and a plurality of side walls. The lid is attached to the main body such that the lid is selectively moveable between a closed position and an open position, thereby covering or exposing the cooking grid and the heat source when the cooking grid and the heat source are received by the main body. The main body and the lid are configured such that the lid is in vertical overlapping arrangement with at least a substantial portion of the cooking grid when the cooking grid is received by the main body and the lid is attached to the main body in a closed position. The main body and the lid are configured such that when the cooking grid and the heat source are received by the main body and the lid is attached to the main body in the closed position, warm air rises vertically from the heat source through the cooking grid to the top wall of the lid, and when the cooking grid and the heat source are received by the main body and the lid is in the open position, warm air rises vertically from the heat source through the cooking grid to an outside of the grill. The lid includes one or more openings in one or more of the front wall and side walls of the lid. Each of the openings is selectively closed and opened by one or more opening members attached to the lid. Each of the opening members is selectively moveable between an open position and a closed position independently of the lid such that one or more of the opening members is openable or closable while the lid remains attached to the main body in the closed position.

In another aspect, the present disclosure relates to a grill that includes a main body possessing a back wall and an open top, and configured to receive a cooking grid and a heat source below the cooking grid; a lid possessing a top wall, a back wall, a front wall, and a plurality of side walls; and one or more hinge members attaching the lid to the main body such that the lid is selectively movable between a closed position and an open position by rotating the lid about the one or more hinge members, thereby covering or exposing the cooking grid and heat source when the cooking grid and the heat source are received by the main body. The main body and the lid are configured such that the lid is in vertical overlapping arrangement with at least a substantial portion of the cooking grid when the cooking grid is received by the main body and the lid is attached to the main body in a closed position. The main body and the lid are configured such that when the cooking grid and the heat source are received by the main body and the lid is attached to the main body in the closed position, warm air rises vertically from the heat source through the cooking grid to the top wall of the lid, and when the cooking grid and the heat source are received by the main body and the lid is attached to the main body in the open position, warm air rises vertically from the heat source through the cooking grid to an outside of the grill. The lid includes one or more openings in the front wall of the lid, each of the one or more openings being selectively closed and opened by one or more hinged doors attached to the lid. Each of the one or more opening members is closable or openable independently of the lid such that one or more of the opening members is openable or closable while the lid remains attached to the main body in the closed position.

### BRIEF DESCRIPTION OF THE DRAWINGS

Other features and advantages disclosed herein will become more apparent from the following detailed description of exemplary embodiments when read in conjunction with the attached drawings, wherein:

FIG. 1 is a schematic illustration of an exemplary embodiment of a grill assembly with a grill lid in a closed position, an opening member in an open position, and another opening member in a closed position;

FIG. 2 is a schematic illustration of an exemplary embodiment of a grill assembly with a grill lid in an open position, an opening member in an open position, and another opening member in a closed position;

FIG. 3 is a schematic illustration of a top view of an exemplary embodiment of a grill assembly with a grill lid in a closed position.

### DETAILED DESCRIPTION

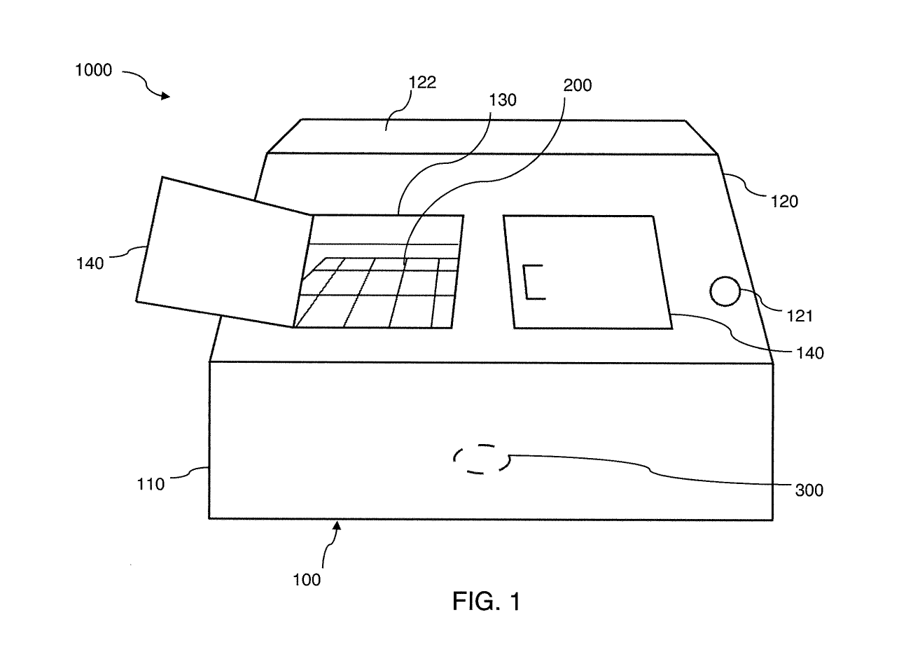

FIGS. 1-3 show exemplary embodiments of a grill assembly 1000, which includes a grill 100, and a cooking grid 200 and a heat source 300 received by the grill 100. The heat source can be any heat source suitable for directing warm air through the cooking grid 200, including charcoal, wood, or a gas burner.

In certain exemplary embodiments, the grill 100 includes a main body 110 possessing a back wall 112 and an open top 114, and configured to receive the cooking grid 200 and the heat source 300 below the cooking grid 200. The grill 100 also includes a lid 120 possessing a top wall 122, a back wall 124, a front wall 126, and a plurality of side walls 128. The shape of the grill 100 and lid 120 can be any desired shape, including, but not limited to, rectangular or circular. The lid 120 can include at least one thermometer 121 measuring the temperature inside the grill 100.

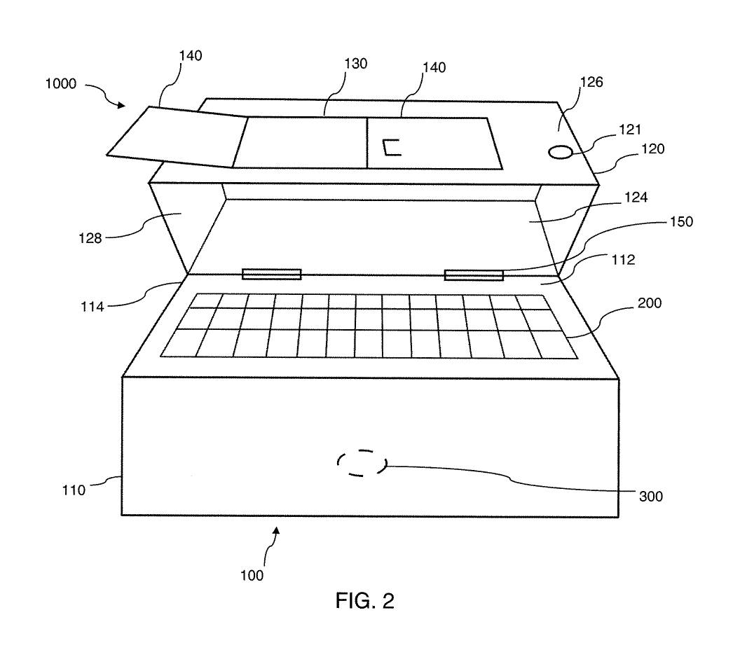

The lid 120 is attached to the main body 110 such that the lid 120 is selectively moveable between a closed position (see FIG. 1) and an open position (see FIG. 2), thereby covering or exposing the cooking grid 200 and the heat source 300 when the cooking grid 200 and the heat source 300 are received by the main body 110. Attachment of the lid 120 to the main body 110 can be by any suitable means. In certain exemplary embodiments, there are no particular means attaching the lid 120 to the main body 110, such that the lid 120 merely is held in place by gravity and it can be completely detached from the main body 110 by having the user lift the lid 120 off of the main body 110. In other exemplary embodiments, the grill 100 includes one or more hinge members 150 attaching the lid 120 to the main body 110 such that the lid 120 is selectively movable between a closed position and an open position by rotating the lid 120 about the hinge member(s) 150. Such hinges can attach the lid 120 to the main body 110, for example, at the back walls 126 and 112 of the lid 120 and the main body 110. In exemplary embodiments, the lid 120 can include a handle (not shown) to facilitate attachment to the main body 110.

In certain exemplary embodiments, the main body 110 and the lid 120 are configured such that the lid 120 is in vertical overlapping arrangement with at least a substantial portion of the cooking grid 200 when the cooking grid 200 is received by the main body 110 and the lid 120 is attached to the main body 110 in a closed position. The main body 110 and the lid 120 are configured such that when the cooking grid 200 and the heat source 300 are received by the main body 110 and the lid 120 is attached to the main body 110 in the closed position, warm air rises vertically from the heat source 300 through the cooking grid 200 to the top wall 122 of the lid 120, and when the cooking grid 200 and the heat source 300 are received by the main body 110 and the lid 120 is attached to the main body 110 in the open position, warm air rises vertically from the heat source 300 through the cooking grid 200 to an outside of the grill 100.

In certain exemplary embodiments, the lid 120 includes one or more openings 130 in one or more of the front wall 126 and side walls 128 of the lid 120. Each opening is selectively closed and opened by one or more opening members 140 attached to the lid 120. Each opening member 140 is selectively moveable between an open position and a closed position independently of the lid 120 such that one or more of the opening members 140 is openable or closable while the lid 120 remains attached to the main body 110 in the closed position. In certain exemplary embodiments, each opening member 140 is selectively movable between a closed position and an open position independently of one another. In other words, one opening member 140 can be opened and closed while another opening member 140 remains open or closed.

Attachment of each opening member 140 to the lid 120 can be by any suitable means. In certain exemplary embodiments, each opening member 140 is attached to the lid 120 by a hinge means. In one exemplary embodiment, the doors are openable by pivoting outward of the grill. In alternative exemplary embodiments, an opening member 140 is openable by pivoting inward of the grill. In other exemplary embodiments, each opening member 140 is attached to the lid 140 via a sliding means such that opening member(s) 140 can be slid (e.g., horizontally, vertically, or in any other direction) to open/expose the opening(s) 130.

In certain exemplary embodiments, each opening member 140 is entirely detachable from the lid 120. For example, an opening member 140 can be attached to the lid 120 by resting against an opening 130, by a press-fitting mechanism, by a snap-fitting mechanism, by a magnetic attachment, or by any other attachment allowing the opening member 140 to cover the opening 130 during cooking and to be selectively removed by a user during cooking.

In further exemplary embodiments, a user can thus selectively open one or more openings 130 independently of the lid 120. This allows the user to access food items during grilling while the lid 120 remains closed, thus preventing excessive escape of warm air from the grill. For example, the user can open an opening member 140 located on the front panel of the grill lid 120 to attend to a piece of food that might be burning or not cooking properly, without undesirably disturbing the cooking process and the cooking temperature of the other food items being grilled. Reduced heat loss allows the user to cook food faster, and at a more constant and controlled temperature, thus leading to more consistent cooking results. By cooking the food faster, the amount of energy needed for grilling is also reduced compared to conventional systems.

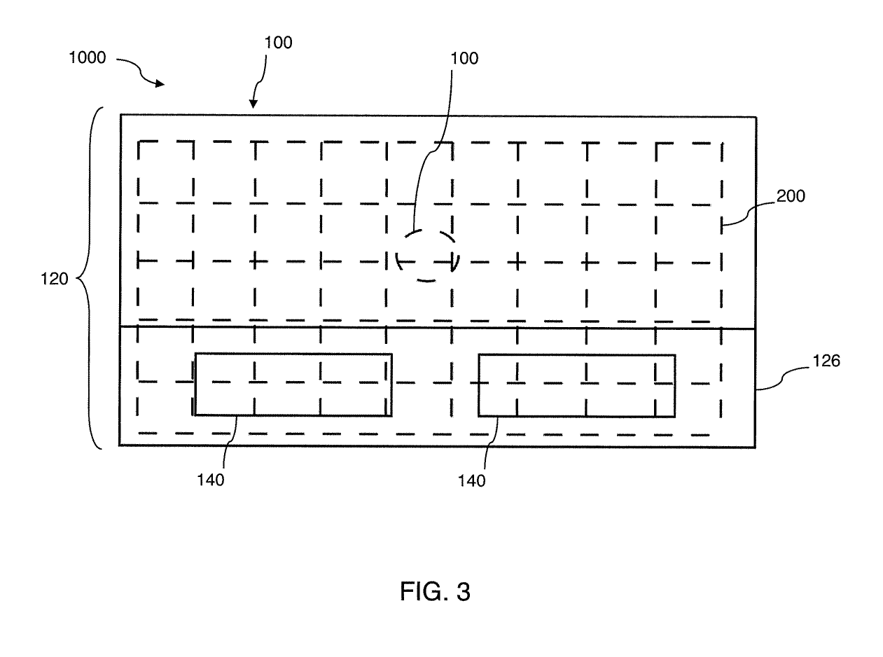

In certain exemplary embodiments, the front wall 126 of the lid 120 comprises a first opening 130 and a second opening 130, with a first opening member 140 configured to selectively close and open the first opening 130, and a second opening member 140 configured to selectively close and open the second opening 130. In certain exemplary embodiments, the first opening member 140 includes a first door hinged to the front wall 126 of the lid 120, and the second opening member 140 includes a second door hinged to the front wall 126 of the lid 120 (see FIGS. 1 and 3).

In another exemplary embodiment, the front wall 126 of the lid 120 comprises single opening 130, with a first opening member 140 and a second opening member 140 configured to selectively close and open the opening 130 (see FIG. 2). In particular exemplary embodiments, each of the first and opening members 140 are slidably attached to lid 120 such that each of first and second opening members 140 can be slid horizontally to open/expose a portion of opening 130. In other exemplary embodiments, the opening members 140 include two doors hinged to the front wall 126 of the lid 120, each of the two doors covering a respective portion of the opening 130 when the opening 130 is closed by the doors (see FIG. 2). In another exemplary embodiment, the front wall 126 of the lid 120 comprises multiple openings 130, and a single opening member 140 configured to selectively close and open the multiple openings 130.

In another exemplary embodiment, the grill 100 is configured to receive multiple cooking grids 200, and includes multiple opening 130, each providing access to a respective cooking grid 200.

In one exemplary embodiment, the front wall 126 of the lid 120 is disposed at an angle greater than 90 degrees relative to the top wall 122 of the lid 120. Alternatively, the front wall 126 of the lid 120 can be disposed at an angle of 90 degrees or less, relative to the top wall 122 of the lid 120. In an exemplary embodiment, the lid 120 is curved.

In another exemplary embodiment, a projection of the front wall 126 of the lid 120 onto a horizontal plane of the cooking grid 200 spans less than half of an upward facing surface area of the cooking grid 200 when the cooking grid 200 is received by the main body 110 of the grill 100 and when the lid 120 is attached to the main body 110 in a closed position (see FIG. 3). In another exemplary embodiment, a projection of one of the plurality of side walls 128 of the lid 120 onto a horizontal plane of the cooking grid 200 spans less than half of an upward facing surface area of the cooking grid 200 when the cooking grid 200 is received by the main body 110 and when the lid 120 is attached to the main body 110 in a closed position.

### Examples

A grill as described herein was constructed and comparative heat-loss tests were performed to determine the amount of heat lost when the lid is repeatedly opened, as would be done with conventional grills, versus when only the opening members are repeatedly opened, as is possible with the grill of the present disclosure. These tests demonstrate that cooking temperature decreases less when the opening members 140 are opened (either a single opening member or two opening members) compared to instances in which the lid 120 is open.

The grill utilized to perform the tests was constructed essentially as shown in FIG. 1. More specifically, the grill included three gas burners as the heat source 300. The lid 120 was attached to the main body 110 via hinges. The front wall 126 of the lid 120 comprised a first opening 130 and a second opening 130, with a first opening member 140 attached to the first opening 130 and a second opening member 140 attached to the second opening 130, wherein each of the opening members 140 were hinged doors.

Table 1 below provides the results of Tests 1 through 6, which consisted of measuring the temperature inside the grill during a simulated cooking environment. Prior to beginning the test, the heat source 300 was activated and the temperature above the cooking grid 200 was raised to 475° F. (ambient temperature was 85° F.). Tests 1-3 were performed with no food items on the cooking grid 200, while Tests 4-6 were performed with food items placed on the cooking grid 200, as would be encountered during typical use of a grill. Tests 1 and 4 were performed by leaving the lid 120 open after initiation of the test and measuring the temperature above the cooking grid 200 at various time intervals. Tests 2 and 5 were performed by leaving a single opening member 140 open and measuring the temperature above the cooking grid 200 at various time intervals. Tests 3 and 6 were performed by leaving two opening members 140 open and measuring the temperature above the cooking grid 200 at various time intervals. The rate of temperature decrease over time was greater during Tests 1 and 4 compared to Tests 2, 3, 5 and 6.

TABLE 1

| | temp inside the grill | | | | | |
|---|---|---|---|---|---|---|
| | | | | grill containing food items | | |
| | empty grill | | | | | two opening |
| time of | | single opening | two opening | | single opening | members |
| temperature | lid open | member open | members open | lid open | member open | open |
| measurement | (Test 1) | (Test 2) | (Test 3) | (Test 4) | (Test 5) | (Test 6) |
| 0 seconds | 475° F. | 475° F. | 475° F. | 475° F. | 475° F. | 475° F. |
| 15 seconds | 428° F. | 475° F. | 460° F. | 430° F. | 455° F. | 450° F. |
| 30 seconds | 350° F. | 455° F. | 450° F. | 359° F. | 455° F. | 429° F. |
| 60 seconds | 285° F. | 451° F. | 430° F. | 286° F. | 440° F. | 396° F. |
| 90 seconds | 282° F. | 451° F. | 412° F. | 262° F. | 403° F. | 373° F. |
| 120 seconds | 282° F. | 451° F. | 412° F. | 242° F. | 385° F. | 355° F. |
| 150 seconds | not measured | 451° F. | 397° F. | 225° F. | 398° F. | 355° F. |
| 180 seconds | not measured | 451° F. | 391° F. | not measured | 387° F. | 350° F. |
| | | | | | | two opening |

Tables 2 and 3 below provide the results of Tests 7 through 12, which consisted of measuring the temperature inside the grill during a simulated cooking environment in a manner similar to the procedures of Tests 1 through 6, but over longer periods of time and at a different ambient temperature. Tests 7 through 12 were performed while the ambient temperature was 35° F. Tests 7-9 (Table 2) were performed with no food items on the cooking grid 200, while Tests 10-12 (Table 3) were performed with food items placed on the cooking grid 200, as would be encountered during typical use of a grill. Tests 7 and 10 were performed by leaving the lid 120 open after initiation of the test and measuring the temperature above the cooking grid 200 at various time intervals. Tests 8 and 11 were performed by leaving a single opening member 140 open and measuring the temperature above the cooking grid 200 at various time intervals. Tests 9 and 12 were performed by leaving two opening members 140 open and measuring the temperature above the cooking grid 200 at various time intervals. The rate of temperature decrease over time was greater during Tests 7 and 10 compared to Tests 8, 9, 11 and 12. Tables 2 and 3 thus show significant temperature loss avoidance when using opening members, instead of opening the full lid.

TABLE 2

| | temp inside the grill (empty) | | | | |
|---|---|---|---|---|---|
| | | | temperature | | temperature |
| | | single | loss | two | loss |
| | | opening | avoidance in | opening | avoidance in |
| time of | | member | Test 8 | members | Test 9 |
| temperature | lid open | open | (compared | open | (compared |
| measurement | (Test 7) | (Test 8) | to Test 7) | (Test 9) | to Test 7) |
| 0 sec | 560° | 560° | 0% | 560° | 0% |
| 15 sec | 523° | 554° | 6% | 554° | 6% |
| 30 sec | 478° | 554° | 16% | 550° | 15% |
| 45 sec | 441° | 552° | 25% | 509° | 15% |
| 60 sec | 405° | 550° | 36% | 496° | 22% |
| 1 min 15 sec | 397° | 549° | 38% | 480° | 21% |
| 1 min 30 sec | 370° | 547° | 48% | 469° | 27% |
| 1 min 45 sec | 347° | 543° | 56% | 468° | 35% |
| 2 min | 340° | 549° | 61% | 460° | 35% |
| 2 min 15 sec | 336° | 543° | 62% | 448° | 33% |
| 2 min 30 sec | 334° | 540° | 62% | 437° | 31% |
| 2 min 45 sec | 329° | 532° | 62% | 424° | 29% |
| 3 min | 300° | 532° | 77% | 433° | 44% |
| 3 min 15 sec | 279° | 531° | 90% | 441° | 58% |
| 3 min 30 sec | 277° | 529° | 91% | 435° | 57% |
| 3 min 45 sec | 277° | 529° | 91% | 423° | 53% |
| 4 min | 275° | 529° | 92% | 444° | 61% |

TABLE 3

| | temp inside the grill (containing food items) | | | | |
|---|---|---|---|---|---|
| | | | temperature | | temperature |
| | | single | loss | two | loss |
| | lid | opening | avoidance in | opening | avoidance in |
| time of | open | member | Test 11 | members | Test 12 |
| temperature | (Test | open | (compared | open | (compared |
| measurement | 10) | (Test 11) | to Test 10) | (Test 12) | to Test 10) |
| 0 sec | 543° | 543° | 0% | 543° | 0% |
| 15 sec | 531° | 540° | 2% | 541° | 2% |
| 30 sec | 482° | 523° | 9% | 520° | 8% |
| 45 sec | 435° | 522° | 20% | 511° | 17% |
| 60 sec | 401° | 522° | 30% | 495° | 23% |
| 1 min 15 sec | 340° | 510° | 50% | 484° | 42% |
| 1 min 30 sec | 313° | 496° | 58% | 469° | 50% |
| 1 min 45 sec | 307° | 489° | 59% | 460° | 50% |
| 2 min | 291° | 487° | 67% | 455° | 56% |
| 2 min 15 sec | 275° | 489° | 78% | 448° | 63% |
| 2 min 30 sec | 262° | 487° | 86% | 444° | 69% |
| 2 min 45 sec | 253° | 478° | 89% | 441° | 74% |
| 3 min | 250° | 477° | 91% | 437° | 75% |

It will be appreciated by those skilled in the art that the disclosure herein can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

I claim:

1. A grill comprising:
a main body possessing a back wall and an open top, and configured to receive a cooking grid and a heat source below the cooking grid;
a lid possessing a top wall, a back wall, a front wall, and a plurality of side walls;
wherein the lid is attached to the main body such that the lid is selectively moveable between a closed position and an open position, thereby covering or exposing the cooking grid and the heat source when the cooking grid and the heat source are received by the main body;
wherein the main body and the lid are configured such that the lid is in vertical overlapping arrangement with at least a substantial portion of the cooking grid when the cooking grid is received by the main body and the lid is attached to the main body in a closed position;
wherein the main body and the lid are configured such that when the cooking grid and the heat source are received by the main body and the lid is attached to the main body in the closed position, warm air rises vertically from the heat source through the cooking grid to the top wall of the lid, and when the cooking grid and the heat source are received by the main body and the lid is attached to the main body in the open position, warm air rises vertically from the heat source through the cooking grid to an outside of the grill; and
the lid including one or more openings in one or more of the front wall and side walls of the lid, each of the one or more openings being selectively closed and opened by one or more opening members attached to the lid, wherein each of the one or more opening members is selectively moveable between a closed position and an open position independently of the lid such that one or more of the opening members is openable or closable while the lid remains attached to the main body in the closed position.

2. The grill of claim 1, wherein the one or more opening members include one or more doors hinged to the front wall of the lid.

3. The grill of claim 1, wherein each of the one or more opening members is selectively movable between a closed position and an open position independently of one another.

4. The grill of claim 1, wherein the one or more opening members include two doors hinged to the front wall of the lid, each of the two doors covering a respective portion of the opening when the opening is closed by the one or more opening members.

5. The grill of claim 1, wherein each of the one or more opening members is entirely detachable from the lid.

6. The grill of claim 1, wherein the lid is entirely detachable from the main body.

7. The grill of claim 1, wherein the lid is hinged to the main body.

8. The grill of claim 1, wherein the front wall of the lid is disposed at an angle greater than 90 degrees relative to the top wall of the lid.

9. The grill of claim 1, wherein a projection of the front wall of the lid onto a horizontal plane of the cooking grid spans less than half of an upward facing surface area of the cooking grid when the cooking grid is received by the main body and when the lid is attached to the main body in a closed position.

10. The grill of claim 1, wherein a projection of one of the plurality of side walls of the lid onto a horizontal plane of the cooking grid spans less than half of an upward facing surface area of the cooking grid when the cooking grid is received by the main body and when the lid is attached to the main body in a closed position.

11. The grill of claim 1, wherein the front wall of the lid comprises a first opening and a second opening with a first opening member configured to selectively close and open the first opening and a second opening member configured to selectively close and open the second opening.

12. The grill of claim 11, wherein the first opening member includes a first door hinged to the front wall of the lid, and the second opening member includes a second door hinged to the front wall of the lid.

13. A grill assembly comprising:
the grill of claim 1; and
a cooking grid received by the main body.

14. The grill assembly of claim 13, wherein a projection of the front wall of the lid onto a horizontal plane of the cooking grid spans less than half of an upward facing surface area of the cooking grid when the lid is attached to the main body in a closed position.

15. The grill assembly of claim 13, wherein the one or more opening members include at least one door hinged to the front wall of the lid.

16. A grill comprising:
a main body possessing a back wall and an open top, and configured to receive a cooking grid and a heat source below the cooking grid;
a lid possessing a top wall, a back wall, a front wall, and a plurality of side walls;
one or more hinge members attaching the lid to the main body such that the lid is selectively movable between a closed position and an open position by rotating the lid about the one or more hinge members, thereby covering or exposing the cooking grid and heat source when the cooking grid and the heat source are received by the main body;
wherein the main body and the lid are configured such that the lid is in vertical overlapping arrangement with at least a substantial portion of the cooking grid when the cooking grid is received by the main body and the lid is attached to the main body in a closed position;
wherein the main body and the lid are configured such that when the cooking grid and the heat source are received by the main body and the lid is attached to the main body in the closed position, warm air rises vertically from the heat source through the cooking grid to the top wall of the lid, and when the cooking grid and the heat source are received by the main body and the lid is attached to the main body in the open position, warm air rises vertically from the heat source through the cooking grid to an outside of the grill; and
the lid including one or more openings in the front wall of the lid, each of the one or more openings being selectively closed and opened by one or more hinged doors attached to the lid, wherein each of the one or more opening members is closable or openable independently of the lid such that one or more of the opening members is openable or closable while the lid remains attached to the main body in the closed position.

17. The grill of claim 16, wherein each of the one or more opening members is closable or openable independently of one another.

18. A grill assembly comprising:
the grill of claim 16; and
a cooking grid received by the main body.
